(19) United States
(12) Patent Application Publication
(10) Pub. No.: US 2002/0079126 A1
(43) Pub. Date: Jun. 27, 2002

(54) Insulated electrical cables

(76) Inventor: Eduardo Dominguez Valenzuela, Monterrey (MX)

Correspondence Address: Edward L. Jensen, Jensen & Associates, L.C., 9337-B Katy Freeway, PMB 313, Houston, TX, 77024, US

(21) Appl. No.: 09/921,830

(22) Filed: Dec. 19, 2000

Related U.S. Application Data
(63) Continuation-in-part of application No. 09/140,990, filed on Aug. 27, 1998, now abandoned.

(51) Int. Cl. H01B 7/00

(52) U.S. Cl. 174/110 R

(57) ABSTRACT

It offers an insulated electrical cable to be used mainly but not exclusively as an underground electricity conductor buried directly, characterized by including basically the functional technical combination of: central conductor wires practically arranged in a cylindrical circular pattern; an interior cylindrical lining that covers the central conductor wires and essentially provides the function of electric insulation, and an exterior lining also practically cylindrical and concentric with the aforementioned elements which carries inside a number of ribs that remain in contact with or tangential to the interior lining, separated by grooves, that provides additional insulation, mechanical protection and protection against environmental elements and accidental blows.

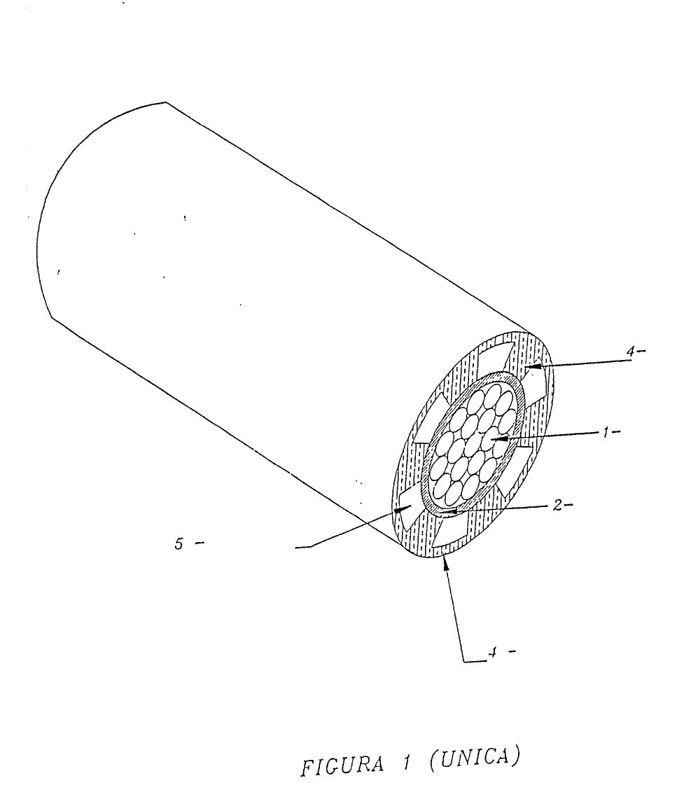

### DESCRIPTION

This description relates in general terms to electrical conductors and more particularly with improvements in insulated electrical cables, that is to say cables that have central conductors lined with insulating materials, such as: Plastics, Rubber or Similar Materials.

A great variety of insulated electrical cables of the type mentioned in the above paragraph is already known, and they consist mainly of copper or aluminum electrical conductors, with a concentric layer of insulating material.

Within the known type we can mention single wire, double wire and multi wire cables, used in diverse applications, generally industrial; these cables are usually placed in appropriate ducts made of for example plastic or metallic materials. Another situation that exits is that of underground cables, buried directly (without ducts), that is to say those that must be placed under ground without duct protection. The invention proposes an improved insulated cable, mainly, although not exclusively, for underground placement: buried directly.

Without the use of protecting duct, and resistant to mechanical damage and abuse from blows with rocks, shovels, etc.

### THE INVENTION

This invention provides, as a new industrial product a conducting insulated cable protected in such a was that it can be “buried” without any additional ducts or pipes and still provide good conduction and resistance to the environment, e.g. humidity and the resulting rust. At the same time, it provides a better resistance to mechanical abuse common in this cable installations and the normal conditions of use.

It basically provides an insulated electrical conductor cable that has at its center a nucleus or central core of conductor wires that essentially serve as an electrical conductor an interior lining or electrical insulation and an exterior cover or lining; the exterior lining includes interior ribs evenly distributed separated by grooves, mainly rectangular in the shape of a trapezium or arches;; the ribs are tangentially placed on the interior lining.

This exterior lining complements the insulating function of the interior lining, also performing mechanical protection functions and against the effects of elements in the soil and accidental blows.

We'll immediately proceed to a detailed description of the insulated electrical cable in the present invention as related to the single picture included, provided as a not limiting example.

Picture 1 (single) shows an insulated cable that basically includes, from the core to the outside: central electrical wires (1) that make the nucleus or conductor cable core and at the same time are responsible for conducting the electrical current, an insulating cylindrical interior lining (2) that holds the interior conductor wires (1); and an exterior cover or lining substantially cylindrical that covers both 1 and 2; the exterior lining (3) includes a number of ribs (4) which upper surface is in touch with that is to say tangential to the interior lining (2), the ribs (4) define the grooves (5) mainly rectangular or in the shape of a trapezium.

The above mentioned design achieves an insulated electrical cable that meets all the requirements sought by this invention, that is to say that it can be buried without a special duct to insulate it besides making it more resistant to mechanical mistreatment when compared with conventional products.

At the same time the cable as described can be assembled (cabled) with two, three or four similar cables in order to make a complete circuit and be installed as such.

Obviously, the materials may vary, with the condition that they still serve their purpose, that is to say that the electric wires must be conductors and the interior lining and exterior cover must be made of insulating material; likewise the size of the cable will vary according to need, and they may have more or less conductor wires as provided by the invention, finally, the lining color will be selected at will, all within the scope of the present invention.

What is claimed is:

1. Insulated electrical cable improvements, to be used mainly although not exclusively as an underground electrical conductor characterized by comprising basically the functional technical combination of: a conductor wire; an interior covering or lining of electrical insulation material around said conductor wire; and an exterior cover or lining generally cylindrical and surrounding the aforementioned elements, which exterior cover is configured inside with a number of ribs that remain in contact with or tangential to the interior covering, separated or spaced apart by grooves.

2. Insulated electrical cable improvements according to claim 1, characterized by the fact that the interior ribs of the exterior cover are evenly distributed and separated by either rectangular, trapezoid or arch-shaped grooves.

3. Insulated electrical cable improvements, to be used mainly although not exclusively as an underground electrical conductor characterized by comprising basically the functional technical combination of:central conductor wires arranged generally in a cylindrical pattern; an interior covering or lining of electrical insulation material around said conductor wires; and an exterior cover or lining generally cylindrical and concentric with the aforementioned elements, which exterior cover is configured inside with a number of ribs that remain in contact with or tangential to the interior covering, separated or spaced apart by grooves.

4. Insulated electrical cable improvements according to claim 3, characterized by the fact that the interior ribs of the exterior cover are evenly distributed and separated by either rectangular, trapezoid or arch-shaped grooves, with corner angles that may be either straight or rounded, to offer additional mechanical protection with lighter weight and better flexibility than that of an exterior cover without ribs and grooves.

9. Insulated electrical cable improvements, to be used mainly although not exclusively as an underground electrical cable, characterized by an integral cable design comprising an electrical conductor; an interior lining of electrical insulation material surrounding said conductor; and an exterior cover surrounding the interior lining, said conductor, lining and cover forming an integral cable, and said exterior cover being configured in the interior with a number of ribs in contact with the interior lining, separated or spaced apart by grooves.

10. Insulated electrical cable improvements according to claim 9, characterized by the fact that the interior ribs of the exterior cover are evenly distributed and separated by either rectangular, trapezoid or arch-shaped grooves.

11. Insulated electrical cable improvements, to be used mainly although not exclusively as an underground electrical cable, characterized by an integral cable design comprising the functional technical combination of central conductor wires arranged generally in a cylindrical pattern; an interior lining of electrical insulation material surrounding said conductor wires; and an exterior cover generally cylindrical and concentric with the interior lining, said conductor wires, lining and cover forming an integral cable, and said exterior cover being configured in the interior with a number of ribs in contact with the interior lining, separated or spaced apart by grooves.

12. Insulated electrical cable improvements according to claim 11, characterized by the fact that the interior ribs of the exterior cover are evenly distributed and separated by either rectangular, trapezoid or arch-shaped grooves, with corner angles that may be either straight or rounded, to offer additional mechanical protection with lighter weight and better flexibility than that of an exterior cover without ribs and grooves.
